(19) United States
(12) Patent Application Publication
(10) Pub. No.: US 2012/0280655 A1
(43) Pub. Date: Nov. 8, 2012

(54) CHARGING SYSTEM FOR ELECTRIC VEHICLES

(75) Inventors: Daniel Schneider, Oberried (DE); Thomas Wick, Beinwil (CH); Gilles Martin, Sausheim (FR)

(73) Assignees: Thomas WICK, Beinwil (CH); Daniel SCHNEIDER, Oberried (DE)

(21) Appl. No.: 13/508,099

(22) PCT Filed: Nov. 3, 2010
(86) PCT No.: PCT/EP2010/066706

§ 371 Date: Jul. 17, 2012

(30) Foreign Application Priority Data
Nov. 5, 2009 (DE) 10 2009 046 422.0

(51) Int. Cl. H02J 7/00

(52) U.S. Cl. 320/109

(57) ABSTRACT

The invention relates to a charging system for electric vehicles. The charging system comprises a grid power stage (12) comprising an AC/DC inverter can be connected on an input side via a connection point to an alternating current grid (10), a control device (38) for monitoring a charging process, and at least one charging connection (24) on an output side, the latter being able to be temporarily connected to a vehicle battery (26). A characteristic of the invention is that a buffer battery (16) having a significantly higher charge capacity than the vehicle battery (26) is connected to the grid charging stage (12). A rapid charging stage (22) comprising the control device (38) and a DC/DC inverter (44) that can be temporarily connected to a vehicle battery (26) on the output side by means of the charging connection (24) is connected to the buffer battery (16). The buffer battery (16) can further be connected to a charging location (52) on the alternating current grid (10) on the output side by means of a backcharging stage (46) comprising a switching unit (48) and a DC/AC inverter (50).

The invention relates to a charging system for electric vehicles, having a grid charging stage that can be connected to an alternating current grid, by way of a connection point, on the input side and has an AC/DC inverter, having a microprocessor-assisted control device for monitoring a charging process, and having at least one charging connector on the output side that can be temporarily connected with a vehicle battery.

Charging systems of this type, which are also referred to as charging stations or electric charging stations, are primarily intended for charging the battery of an electric vehicle that has been at least partially discharged. For this purpose, the electric vehicles usually contain a grid charging device that can be connected to an outlet of the public power grid, using a cable connection. In the meantime, there are increasing numbers of charging stations with a rotary current connector, so that either multiple vehicles can be charged at the same time, or one vehicle can be charged in accelerated manner. In this regard, the plugs and the cable connections correspond to the usual standards for electrical devices. The charging times are relatively long even with the quick-charging stations using rotary current. In order to shorten the waiting times, thought has also been given to exchanging the batteries at charging stations. However, this is very complicated, and not practical due to the great variety of different vehicle batteries.

On the other hand, thought has already been given to the idea that vehicle batteries can be viewed as being part of the power grid. The vehicle battery can be charged when there is an excess of energy, while energy can be drawn from the battery when there is an energy deficiency, and returned to the power grid. In this connection, one also speaks about a vehicle-to-grid system, V2G system for short. In order to achieve effective grid support, however, a great number of electric vehicles would have to be connected to the supply grid at all times, and this is unrealistic.

Proceeding from this, the invention is based on the task of developing a charging system for electric vehicles, of the type indicated initially, that allows a rapid charging process and that can also be used to support the power grid.

To accomplish this task, the combination of characteristics indicated in claim 1 is proposed. Advantageous embodiments and further developments of the invention are evident from the dependent claims.

The solution according to the invention proceeds from the idea that rapid charging requires great current intensity, which requires the use of batteries having a low internal resistance. This is true, above all, for the newly developed batteries on a lithium basis, which have not only a low internal resistance but also a high energy density and long useful lifetime. The internal resistance is so small that a charging current of about 500 amperes should be possible. The operating voltage of 100 to 400 volts that is aimed at is achieved by means of switching a plurality of battery cells one behind the other.

The solution according to the invention essentially consists in that a buffer battery having a significantly greater charging capacity as compared with the vehicle battery is connected with the grid charging stage of the charging system, and that a quick-charging stage that comprises the control device and a DC/DC inverter and can be temporarily connected with the vehicle battery on the output side, by way of the charging connector, is connected with the buffer battery. Furthermore, it is proposed, according to the invention, that the buffer battery can be connected to the alternating current grid, on the output side, by way of a return stage that has a microprocessor-assisted switching unit and a DC/AC inverter.

Using the measures according to the invention, not only the grid charging stage but also the quick-charging stage, together with the buffer reservoir and the return stage, are moved out of the electric vehicle into the charging station. The charging station contains a charging connector that can be connected with the vehicle battery by way of a suitable connection system, particularly a cable having a plug connection. The buffer battery ensures that very great currents, which allow effective rapid charging, can be drawn from the charging system to charge the vehicle battery. Charging of the buffer reservoir from the alternating current grid, on the other hand, does not require any rapid charging. Instead, charging can take place uniformly, at moderate current intensities, from the alternating current grid, without any overload occurring there. Of course, the charging capacity of the buffer battery must be dimensioned in such a manner that it meets the needs of the charging demand of the incoming motor vehicles. The latter means that a relatively great amount of electrical energy must always be kept available in the buffer batteries of the charging stations, which energy can be temporarily returned to the alternating current grid in the event that a peak load occurs. Because direct access to the buffer battery exists by way of the charging system, a very rapid switching process is possible. In this way, the waiting time until additional peak load power plants are switched in can be bridged, while avoiding an impermissible load drop in the alternating current grid.

A preferred embodiment of the invention provides that the charging connector comprises a plug connection that has at least two data contacts that are connected with the control device and with a monitoring device on the vehicle side. In this way, an electric vehicle connected with the charging system or its battery can be clearly identified and monitored with regard to its charging state during the subsequent charging process. For this purpose, it is advantageous if the monitoring device on the vehicle side can have analog current-dependent and voltage-dependent signals of the vehicle battery applied to it, and transmits the signals to the control device of the quick-charging stage, in digitalized form, by way of the data contacts, for evaluation and for control of the DC/DC inverter. In order to make do with as few as possible, preferably two data contacts, it is practical if these form an interface in a digital CAN bus. Another preferred embodiment of the invention provides that the buffer battery is connected with a battery management system for control of the charging process and for monitoring and equalization of the charging state of the individual battery cells of the buffer battery. The battery management system ensures that each individual cell is monitored during the charging and discharging process, so that no over-charging, which could lead to an impermissible temperature increase, can occur even locally.

According to another advantageous embodiment of the invention, the grid charging stage has a diode bridge having a power factor correction filter. The power factor correction filter (PFC module) ensures that the diode bridge that is connected with the buffer battery does not give off any impermissible peak voltages. The voltage progression at the output of the diode bridge is therefore not triangular, but rather sine-shaped. Preferably, the power factor correction filter of the grid charging stage comprises a DC/DC converter for increasing the voltage, having a high-frequency diode bridge, the output frequency of which amounts to a multiple of the grid frequency, and the output voltage of which is coordinated with the voltage requirements of the buffer battery. Schottky diodes are disposed in the high-frequency diode bridge.

Another preferred embodiment of the invention provides that the return stage has a DC/DC inverter connected with the buffer battery, a high-frequency transformer connected to this inverter, and a diode bridge connected with the transformer, and that the diode bridge can be charged to the amplitude voltage at the current grid frequency of the power grid, by way of a filter capacitor connected with the transistor bridge.

According to another preferred embodiment of the invention, a central control connected with the alternating current grid is provided, which control has a frequency comparator to which the grid frequency can be applied, on the input side, which comparator switches either the grid charging stage or the return stage through, as determined by a deviation of the grid frequency from a predetermined frequency threshold value, by way of a switching unit, in each instance. It is practical if the grid charging stage is switched on above the predetermined frequency threshold value, and the return stage is switched off, while the return stage is switched on below the predetermined frequency threshold value and the grid charging stage is switched off. In the latter case, the return stage is switched off by way of the central control and/or the battery management system when the charging state of the buffer battery drops below a predetermined limit.

These measures are based on the idea that the power grid is regulated to a defined frequency of 50 or 60 Hz by way of the power plant. If the power grid is overloaded, the frequency drops. The frequency comparator in the central control ensures that the overload is temporarily compensated by demanding support current from the buffer battery. This measure is particularly effective if a great number of charging stations possess a similar charging system, forming a peak load system, in its entirety, that can provide noteworthy support of the power grid. In this regard, each charging station is autonomous and will provide support current under the condition that the frequency drops below the predetermined frequency threshold value. This can take place at all the charging stations, independent of one another, so that no additional regulation mechanisms are required for coupling them.

It is advantageous if the central control additionally has an operating station for data input and output.

In the following, the invention will be explained in greater detail, using the exemplary embodiment shown schematically in the drawing. This shows:

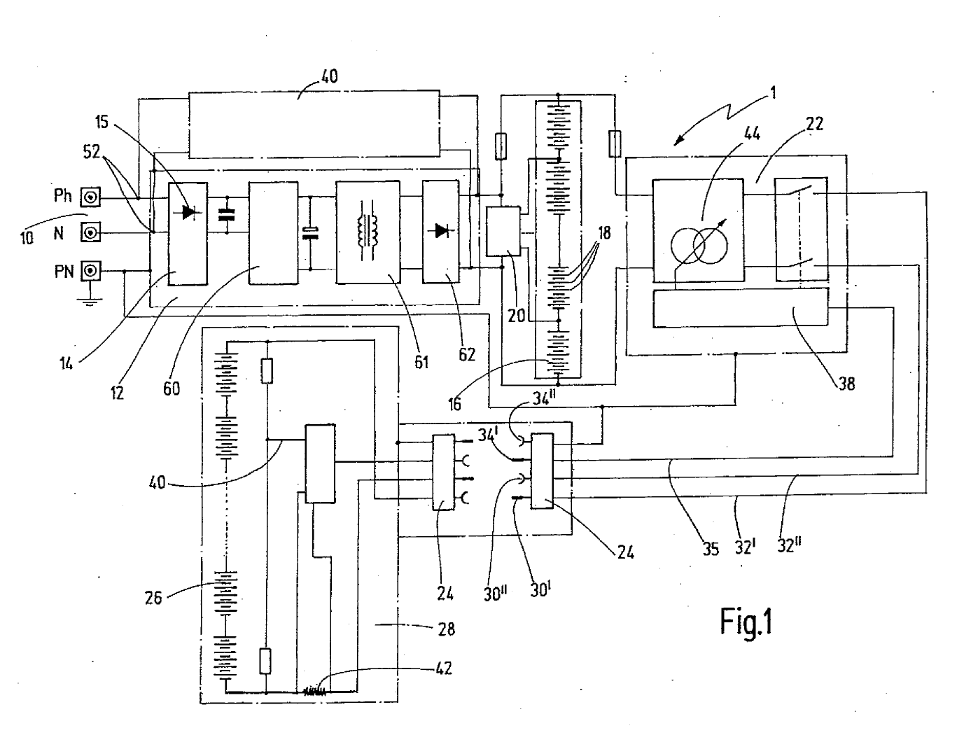

FIG. 1 a block schematic of a charging system with grid charging stage, buffer battery, quick-charging stage, and grid return stage;

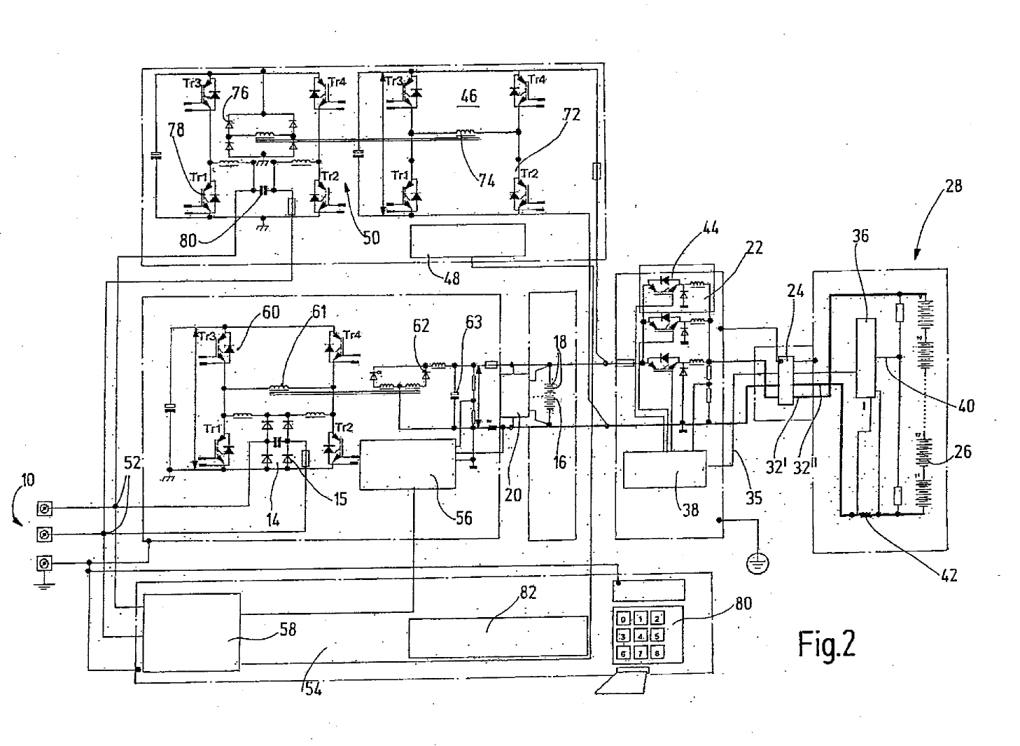

FIG. 2 the block schematic according to FIG. 1, with detailed circuits of the individual switching stages.

The charging system 1 shown in FIG. 1 in the form of a block schematic and in FIG. 2 in somewhat more detail is intended for charging vehicle batteries 26 in electric vehicles 28, in the manner of a charging station or electric charging station. The charging system 1 comprises a grid charging stage 12 that is connected, in the exemplary embodiment shown, on the input side, to a single-phase alternating current grid 10, with a phase conductor or outer conductor Ph, a neutral conductor N, and a protective conductor PN. The grid charging stage 12 contains an AC/DC inverter 14, to the output of which a buffer battery 16 is connected.

The AC/DC inverter 14 has a diode bridge 15 having a power factor correction filter 60 also referred to as a PFC module. The power factor correction filter 60 ensures that the diode bridge 15, which is connected with the buffer battery 16 on the output side, does not give off any impermissible peak voltages. The voltage progression over time is therefore not triangular at the output of the diode bridge, but rather sine-shaped. Preferably, the power factor correction filter comprises a DC/DC converter 61 for increasing the voltage, having a high-frequency diode bridge 62, the output frequency of which converter amounts to a multiple of the grid frequency, and the output frequency of which is coordinated with the voltage requirements of the buffer battery 16. The latter is brought about by means of the output capacitor 63.

The buffer battery 16 has a plurality of individual cells 18, which are switched in series and, if necessary, also in parallel. The buffer battery 16 is connected, on the input side, to a battery management system (BMS) 20 for control of the charging process and for equalization of the charging state of the battery cells 18. The battery management system 20 ensures that each individual cell 18 is monitored during the charging and discharging process, so that no over-charging, which could lead to an impermissible temperature increase, can occur even locally.

The charging system furthermore comprises a quick-charging stage 22 that is connected with the buffer battery 16 on the input side, and that has a charging connector 24 on the output side, which can be temporarily connected with the vehicle battery 26 of an electric vehicle 28 for charging purposes. In the exemplary embodiment shown, the charging connector 24 contains a plug connection having two charging contacts 30′, 30″ for the power-carrying cables 32′, 32″, and having two data contacts 34′, 34″. The data contacts 34′, 34″ form an interface in a bus system, for example a CAN bus 35, by way of which data exchange takes place between a monitoring device 36 on the vehicle side and a microprocessor-assisted control device 38 in the quick-charging stage 22. In this way, an electric vehicle 28 connected with the charging system 1 or its vehicle battery 26 can be clearly identified and monitored with regard to its charging state, during the charging process. The monitoring device 36 on the vehicle side is equipped with a voltage splitter 40 for measuring the battery voltage, and with a shunt 42 for measuring the charging current. The analog current-dependent and voltage-dependent signals detected by the monitoring device 36 in this manner are transmitted, in digitalized form, by way of the data contacts 34, 34′, to the control device 38 of the quick-charging stage 22 for evaluation and for control of a DC/DC inverter 44 disposed in the quick-charging stage.

In place of the galvanic connection by way of the charging contacts 30′, 30″ in a conductive charging system, a wireless connection by way of an induction link (inductive charging system) is fundamentally also possible. On the other hand, in place of the galvanic connection by way of the data contacts 34′, 34″, wireless data transmission an inductive or capacitative coupling link, by way of a radio link, an infrared link, or a Bluetooth link, is also possible.

The buffer battery 16 ensures that very great currents can be drawn from the charging system 1 for charging the vehicle battery 26 by way of the quick-charging stage 22. On the other hand, charging of the buffer battery 16 from the alternating current grid 10 does not require rapid charging. Instead, charging can take place uniformly, at moderate current intensities on the order of 16 to 32 amperes, from the alternating current grid 10, without any overload coming about.

A particular feature of the invention consists in that furthermore, a return stage 46 is connected with the buffer battery 16, on the output side, which stage has a microprocessor-assisted switching unit 48 and can be connected with the alternating current grid 10 by way of an AC/DC inverter 50, at a feed point 52. For this purpose, the return stage 46 has a DC/DC converter 72 connected with the buffer battery 16, a high-frequency transformer 74 connected with this converter, and a diode bridge 76 connected with the transformer, which performs the DC/AC conversion. Furthermore, a diode bridge can be charged to the amplitude voltage at the current grid frequency of the alternating current grid 10, by way of a filter capacitor 79 connected with the transistor bridge 78.

The charging capacity of the buffer battery 16 is dimensioned in such a manner that it meets the needs of the charging demand of the incoming vehicles. The latter means that a relatively large amount of electrical energy is always kept available in the buffer battery 16 of the charging stations, which energy can be temporarily fed back into the alternating current grid 10 if a peak load occurs. Because direct access to the buffer battery 16 exists by way of the charging system 1, a very rapid switching process is possible. In this way, the waiting time until additional peak load power plants are added can be bridged without an impermissible reduction in load in the alternating current grid 10.

For this purpose, the charging system furthermore has a central control 54 that has a frequency comparator 58 to which the grid frequency is applied on the input side and which is coupled with the grid charging stage 16 and the return stage 46 by way of a switching unit 56, 48, in each instance, on the output side. Either the grid charging stage or the return stage is switched through, by way of the switching unit, in each instance, as determined by a deviation of the grid frequency from a predetermined frequency threshold value, by way of the frequency comparator 58. In normal operation, the grid frequency is 50 Hz, for example. If the alternating current grid is overloaded, the grid frequency drops. By way of the frequency comparator 58 in the central control 54, the result can be achieved that the overload is temporarily compensated by a demand for support current from the buffer battery. This is achieved in that the return stage 46 is switched through by way of the frequency comparator 58 and the switching unit 48, and the grid charging stage 12 is switched off by way of the switching unit 56, if the grid frequency drops below a predetermined frequency threshold value of 48.5 Hz, for example. This measure is particularly effective if a great number of charging stations with similar charging systems, independent of one another, is present, which stations, in their totality, can provide noticeable support to the alternating current network 10 in the manner of a peak load system.

The central control 54 furthermore has an operating station 80 for data input and output, or for an Internet remote control 82.

In summary, the following should be stated: The invention relates to a charging system for electric vehicles. The charging system comprises a grid charging stage 12 that can be connected to an alternating current grid 10, by way of a connection point, on the input side and has an AC/DC inverter, having a control device 38 for monitoring a charging process, and having at least one charging connector 24 on the output side that can be temporarily connected with a vehicle battery 26. A particular feature of the invention consists in that a buffer battery 16 having a significantly greater charging capacity as compared with the vehicle battery 26 is connected with the grid charging stage 12. A quick-charging stage 22 that comprises the control device 38 and a DC/DC inverter 44 and can be temporarily connected with the vehicle battery 26 on the output side, by way of the charging connector 24, is connected with the buffer battery 16. Furthermore, the buffer battery 16 can be applied to the alternating current grid 10, on the output side, by way of a return stage 46 that has a switching unit 48 and a DC/AC inverter 50, at a feed point 52.

### REFERENCE SYMBOL LIST

1 charging system
10 alternating current grid
12 grid charging stage
14 AC/DC inverter
15 diode bridge
16 buffer battery
18 individual cell
20 battery management system
22 quick-charging stage
24 charging connector
26 vehicle battery
28 electric vehicle
30′, 30″ charging contacts
32′, 32″ cables
34′, 34″ data contacts
35 CAN bus
36 monitoring device
38 control device
40 voltage splitter
42 shunt
44 DC/DC inverter
46 return stage
48 switching unit
50 DC/AC inverter
52 feed point
54 central control
56 switching unit
58 frequency comparator
60 power factor correction filter
61 DC-DC converter
62 high-frequency diode bridge
63 output capacitor
72 DC-DC converter
74 high-frequency transformer
76 diode bridge
78 transistor bridge
79 filter capacitor
80 operating station
82 Internet remote control

1. Charging system for electric vehicles, having a grid charging stage (12) that can be connected to an alternating current grid (10), by way of a connection point, on the input side and has an AC/DC inverter (14), having a preferably microprocessor-assisted control device (38) for monitoring a charging process, and having at least one charging connector (24) on the output side that can be temporarily connected with a vehicle battery (26), wherein a buffer battery (16) having a significantly greater charging capacity as compared with the vehicle battery (26) is connected with the grid charging stage (12), wherein a quick-charging stage (22) that comprises the control device (38) and a DC/DC inverter (44) and can be temporarily connected with the vehicle battery (26) on the output side, by way of the charging connector (24), is connected with the buffer battery (16), and wherein the buffer battery (16) can furthermore be connected to the alternating current grid (10), on the output side, by way of a return stage (46) that has a DC/AC inverter (50).

2. Charging system according to claim 1, wherein the charging connector (24) comprises a plug connection that has at least two data contacts (34′, 34″) that are connected with the control device (38) and with a monitoring device (36) on the vehicle side.

3. Charging system according to claim 2, wherein the monitoring device (36) on the vehicle side can have analog current-dependent and voltage-dependent signals of the vehicle battery (26) applied to it, and transmits these to the control device (38) of the quick-charging stage (22), in digitalized form, by way of the data contacts (34′, 34″), for evaluation and for control of the DC/DC inverter (44).

4. Charging system according to claim 2, wherein the data contacts (34′, 34″) form an interface in a digital CAN bus (35).

5. Charging system according to claim 1, wherein the charging connector (24) has an inductive energy transmission link, and wherein the control device (38) is connected with a monitoring device (36) on the vehicle side by way of a wireless data transmission link.

6. Charging system according to claim 5, wherein the data transmission link is configured as an inductive or capacitative coupling link, as a radio link, as an infrared link, or as a Bluetooth link.

7. Charging system according to claim 1, wherein the buffer battery (16) is connected with a battery management system (20) for control of the charging process and for monitoring and equalization of the charging state of the individual battery cells (18).

8. Charging system according to claim 1, wherein the grid charging stage (12) has a diode bridge (15) having a power factor correction filter (60).

9. Charging system according to claim 8, wherein the power factor correction filter (60) of the grid charging stage (12) comprises a DC/DC converter (61) having a high-frequency diode bridge (62), the output frequency of which amounts to a multiple of the grid frequency, and the output voltage of which is coordinated with the voltage requirements of the buffer battery (16).

10. Charging system according to claim 9, wherein Schottky diodes are disposed in the high-frequency diode bridge (62).

11. Charging system according to claim 1, wherein the return stage (46) has a DC/DC converter (72) connected with the buffer battery (16), a high-frequency transformer (74) connected to this converter, and a diode bridge (76) connected with the transformer, and wherein the diode bridge (76) can be charged to the amplitude voltage of the alternating current grid (10), at its current grid frequency, by way of a filter capacitor (79) connected with the transistor bridge (78).

12. Charging system according to claim 1, comprising a central control (54) that has a frequency comparator (58) to which the grid frequency of the alternating current grid (10) can be applied, on the input side, and that is connected, by way of a switching unit (56, 48), in each instance, with the grid charging stage (12) and the return stage (46), which comparator switches either the grid charging stage (12) or the return stage (46) through, as determined by a deviation of the grid frequency from a predetermined frequency threshold value, by way of the switching unit (56, 48), in each instance.

13. Charging system according to claim 12, wherein the grid charging stage (12) is switched on above a predetermined frequency threshold value, and the return stage (46) is switched off, and wherein the return stage (46) is switched on below the predetermined frequency threshold value and the grid charging stage (12) is switched off.

14. Charging system according to claim 1, wherein the return stage (46) can be switched off when the charging state of the buffer battery (16) drops below a predetermined limit.

15. Charging system according to claim 12, wherein the central control (54) has an operating station for data input and output.

16. Peak load system for feeding alternating current into an alternating current grid, wherein a plurality of autonomous charging systems (1) according to claim 1 is coupled into the alternating current grid (10) with the alternating current output of its return stage (46), at different feed points.

17. Peak load system according to claim 16, wherein the charging systems (1) have a frequency comparator (58) to which the frequency of the alternating current grid (10) is applied, on the input side, and that is connected, by way of a switching unit (48), with the return stage (46), which comparator switches the return stage (46) through, as determined by a deviation of the grid frequency from a predetermined frequency threshold value.
